(19) United States
(12) Patent Application Publication
(10) Pub. No.: US 2009/0030955 A1
(43) Pub. Date: Jan. 29, 2009

(54) Automated data backup with graceful shutdown for vista-based system

(75) Inventors: Jeffrey Brunet, Richmond Hill (CA); Yousuf Chowdhary, Maple (CA); Ian Collins, Markham (CA)

Correspondence Address: Gard and Kaslow, LLP, One 1st Street, Suite 9, Los Altos, CA, 94022, US

(73) Assignee: Storage Appliance Corporation

(21) Appl. No.: 12/284,682

(22) Filed: Sep. 24, 2008

Related U.S. Application Data
(63) Continuation-in-part of application No. 12/157,671, filed on Jun. 11, 2008.
(60) Provisional application No. 60/995,115, filed on Sep. 25, 2007.
(60) Provisional application No. 60/933,972, filed on Jun. 11, 2007.

(51) Int. Cl. G06F 17/30

(52) U.S. Cl. 707/204; 707/E17.01

(57) ABSTRACT

A data backup device including a backup application is plugged into a data source running the Microsoft Windows Vista operating system. The data backup device reports itself as a removable storage device to the Vista OS thus causing the AutoRun functionality of Vista to locate and launch the backup application which performs a backup operation on the data source. Launching the backup application can be via an automated installation and launch process. Should the backup device become unplugged from the data source, the backup application is gracefully shutdown. The backup device including the backup application can be created by downloading a backup package containing the backup application and installing it on a user-specified device.

### CROSS-REFERENCE TO RELATED APPLICATIONS

This application claims the benefit of U.S. Provisional Patent Application No. 60/995,115 filed on Sep. 25, 2007 and entitled “Automated Self-Contained Portable Electronic Data Backup Appliance;” this application is also a continuation-in-part application of, and claims priority to, U.S. Non-Provisional patent application Ser. No. 12/157,671 filed on Jun. 11, 2008 and entitled “System and Method for Automated Installation and/or Launch of Software” which claims the benefit of U.S. Provisional Patent Application No. 60/933,972 filed on Jun. 11, 2007 and entitled “Method and a System for an Intelligent Launcher for Software Applications.” Each of the aforementioned applications is incorporated herein by reference.

### BACKGROUND OF THE INVENTION

1. Field of the Invention

The present invention relates generally to the field of digital data management and more particularly to systems for data backup applications.

2. Description of the Prior Art

Digital content, represented by digital data files of various file types, is rapidly replacing other forms of content. Documents, presentations, photos, movies, and music, for example, are increasingly produced and stored digitally. A problem for many individuals and organizations is that digital content, typically stored on a computer hard drive, can be poorly organized and needs to be archived to be protected against accidental loss. For example, digital photo files on a personal computer (PC) are likely to be found in numerous folders—photos transferred from a digital camera are stored in one set of folders, photos received as e-mail attachments are stored in other folders, and photos downloaded from websites are stored in still other folders.

One approach to archiving digital content is to periodically backup all of the data files on the computer, preserving the existing organizational structure. While this technique is effective to preserve digital content against accidental loss, the technique has several shortcomings. For one, the resulting copy is no better organized than the original, so misplaced or disorganized content remains misplaced or disorganized. Also, backing up all data files requires substantial memory capacity to copy numerous files that are otherwise already preserved elsewhere. Application specific files, for example, originally loaded onto the computer from a compact disc (CD) are already archived on the CD and therefore do not need to be backed up.

The necessary storage capacity for a complete backup can be obtained with writable data storage media, such as hard disc drives (HDDs), however, these require device installation and software set-up when first connected to a system. In order to complete these steps, a user may have to provide information about the existing system, which the user may not readily know. Also, the user may have to make decisions regarding the configuration of the device and the backup software. The number of steps involved with installation and set-up, as well as the complexity of some of the steps, dissuades many users from bothering with backup applications. The expense of a writable data storage media with enough capacity to perform a complete backup can also dissuade users from performing complete backups. Furthermore, some users, having bought and installed the necessary storage capacity, are dissuaded from performing frequent backups due to the length of time the system is tied up while performing a complete backup.

Alternately, a user can manually select a set of files from a directory and copy the selected files to a storage device. While this alternative may allow usage of a smaller memory device that does not require installation and configuration set-up steps, manually selecting files is time-consuming and potentially technically difficult or complex for some users. Also, manually selecting files creates the possibility of an accidental omission of some files.

What is needed, therefore, is the ability to selectively backup digital content in a manner that is simple and convenient for the average user.

### SUMMARY

An exemplary method of backing up data from a data source running a Microsoft Windows Vista operating system is provided. The method comprises: Vista recognizing that a backup device has been plugged into the data source; the backup device reporting itself to Vista to be a removable storage device; Vista locating and launching, in response to the backup device reporting itself to be a removable storage device, a backup application located on the backup device; the backup application performing a backup operation of the data source; Vista recognizing that the backup device has become unplugged from the data source; and the backup application performing a graceful shutdown. In a further embodiment, the method comprises downloading a backup device package including the backup application and installing the backup device package including the backup application on the backup device. In a still further embodiment, the method comprises performing an automated installation and launch of the backup application on the data source.

An alternative exemplary method of backing up data from a data source running a Microsoft Windows Vista operating system is provided. The alternative method comprises: plugging the backup device into the data source running Vista; the backup device reporting itself to Vista as a removable storage device; launching a backup application located on the backup device using an AutoRun functionality of Vista; performing a backup operation on the data source using the backup application; unplugging the backup device from the data source; and gracefully shutting down the backup application. In a further embodiment, this alternative exemplary method comprises downloading a backup device package including the backup application and installing the backup device package including the backup application on the backup device. In a still further embodiment, the method comprises performing an automated installation and launch of the backup application on the data source.

Another alternative exemplary method of backing up data from a data source running a Microsoft Windows Vista operating system is provided. The alternative method comprises: downloading a backup device package including a backup application, executable code for a backup device to report itself to be a removable storage device and executable code for performing a graceful shutdown of the backup application; installing the backup device package on the backup device; plugging the backup device into the data source running Vista; Vista recognizing that the backup device has been plugged into the data source; the backup device reporting itself to Vista to be a removable storage device via the executable code for the backup device to report itself as a removable storage device; Vista locating and launching, in response to the backup device reporting itself to be a removable storage device, the backup application located on the backup device; the backup application performing a backup operation of the data source; Vista recognizing that the backup device has become unplugged from the data source; and performing a graceful shutdown of the backup application using the executable code for performing the graceful shutdown of the backup application. In a further embodiment, the method comprises performing an automated installation and launch of the backup application on the data source.

### BRIEF DESCRIPTION OF DRAWINGS

FIG. 1 is a flowchart representation of an exemplary method for backing up data files from a data source running the Microsoft Windows Vista operating system according to an exemplary embodiment of the present invention.

FIG. 2 is an expanded flowchart representation of the step of FIG. 1 of locating the backup application stored on the backup device and launching the backup application using the Vista AutoRun functionality according to an exemplary embodiment of the present invention.

FIG. 3 is an expanded flowchart representation of the step of FIG. 1 of performing a graceful shutdown of the backup application according to an exemplary embodiment of the present invention.

FIG. 4 is a flowchart representation of an exemplary method for creating a backup device containing the backup application according to an exemplary embodiment of the present invention.

### DETAILED DESCRIPTION OF THE INVENTION

A data backup device including a backup application in the form of computer readable instructions is provided. When the data backup device is plugged into a data source running the Microsoft Windows Vista operating system (OS) the data backup device reports itself as a removable storage device to the Vista OS. This causes the AutoRun functionality of Vista to locate and launch the backup application. Once launched, the backup application performs a backup operation on the data source. In this way, a backup operation can be performed with little or no user involvement beyond plugging the backup device into the data source running Vista. Further, should the backup device become unplugged from the data source, the backup application is gracefully shutdown thus further minimizing user involvement.

In a further embodiment, the backup device including the backup application is created by downloading a backup package of computer readable instructions containing the backup application and installing the backup package containing the backup application and associated components, as further described elsewhere herein, onto a user-provided storage medium. After the backup package containing the backup application is installed onto the user-provided storage medium the resulting backup device operates as described elsewhere herein.

It is to be understood that the backup device can be any storage media which can be plugged into a data source running Vista. Examples include hard disk drives, optical discs (such as compact disc read only memory (CD-ROM) or digital versatile disc (DVD)), and flash memory cards or USB flash drive (UFD) devices such as key drives, pen drives, jump drives, thumb drives, memory sticks, or the like. Similarly, it is to be understood that a data source can be any processing or computing system that can run the Microsoft Windows Vista operating system. Example data sources include personal computers (desktop or laptop), servers, clients, set-top boxes, game consoles, etc.

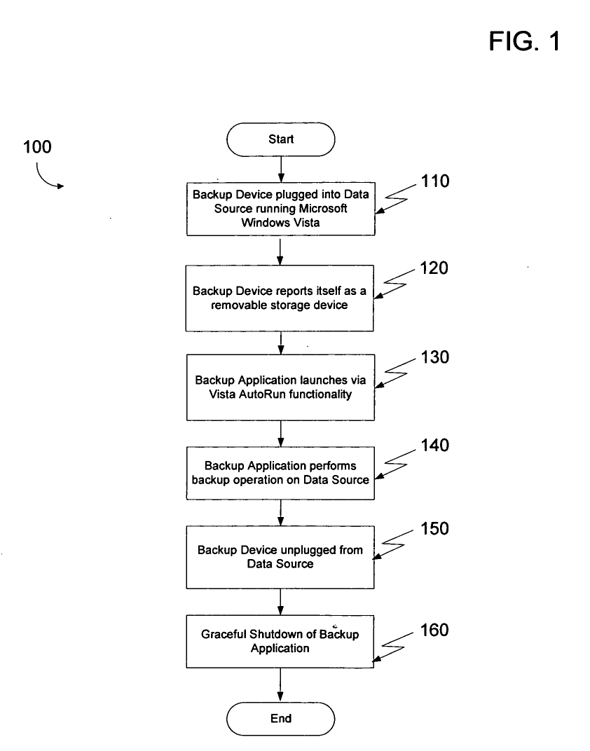

Referring now to FIG. 1, a flowchart representation of an exemplary method 100 for backing up data files from a data source running Vista can be seen. The method 100 begins when, in step 110, the backup device is plugged into a data source running the Microsoft Windows Vista operating system. This may occur, for example, when a user plugs the backup device into the data source. As is known in the art, when Vista detects that something has been plugged into the data source upon which it is running, Vista performs a series of enumeration operations to communicate with and set-up the operation of whatever has been plugged in. In response, in step 120, the backup device reports itself to Vista as a removable storage device. This causes Vista, in step 130, to use its AutoRun functionality to locate a backup application on the backup device and launch the backup application as explained further elsewhere herein. Once launched, in step 140, the backup application performs a backup operation on the data source. The backup device may then become unplugged from the data source, in step 150, when, for example, the user unplugged it. In response, in step 160, the backup application performs a graceful shutdown as explained further elsewhere herein.

Plugging the backup device into the data source, step 110, may occur when, for example, a user plugs a flash memory card containing the backup application into a reader connected to or within the data source. Similarly, this may occur when the user plugs an external hard disk drive containing the backup application into the data source.

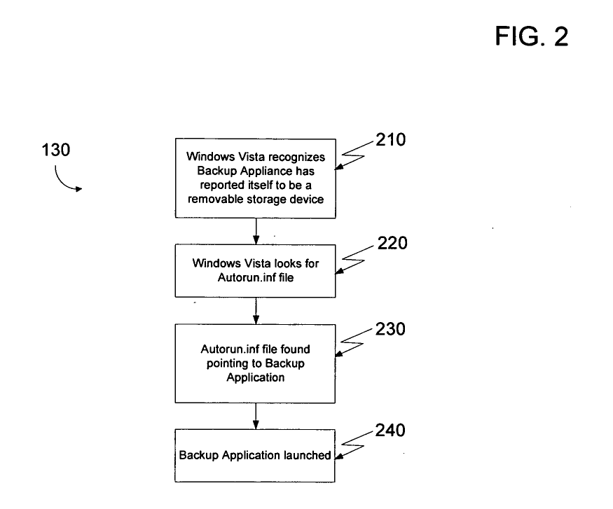

Referring now to FIG. 2, an expanded flowchart representation of step 130 of FIG. 1 for locating the backup application stored on the backup device and launching the backup application using the Vista AutoRun functionality can be seen. In step 210, Vista recognizes that the backup device has reported itself to be a removable storage device. In response, in step 220, the Vista AutoRun functionality is invoked thus triggering a search for an “Autorun.inf” file on the backup device. In step 230, the Autorun.inf file, which points to the backup application, is found on the backup device which, in step 240, causes the backup application to be launched. In this way, the backup application will be automatically launched by the user merely plugging the backup device into the data source running the Vista operating system.

Referring again to FIG. 1, in step 140, the backup application performing a backup operation of the data source can include any of a large variety of backup operations. Such backup operation can include searching for files of a predefined data type in order to make backup copies of such files. Making backup copies of such files can include storing copies of the data files onto the backup device and/or storing copies of the data files onto a networked storage.

In one embodiment, the backup application selects files for backup that meet at least one criterion, such as file type (e.g., .jpg) or type of content (e.g., audio files). The backup application can also find files that meet at least one of several criteria. Other examples of types of content include e-mails, business application data (e.g., Accpac and Simply Accounting files), digital video files, ebook files, contacts files, calendar files, text files, tasks files, settings files, bookmark files, and password files. Another criterion, in some embodiments, is whether a file has been previously backed up. Yet another criterion can be a particular date or a range of dates. The backup application, in some embodiments, finds files that meet the criteria by searching e-mail attachments and files embedded within other files, such as compressed files within a .zip file. The backup application can find files that are stored directly on the data source, or additionally on associated peripheral devices and networks.

The backup application can, in some embodiments, create a file path or directory structure as part of the backup operation to indicate the location where a copied file was located on the data source. In other embodiments, the backup application creates a new directory structure based on chronological order, alphabetical order, file size, or some other criteria. Another alternative is for the backup application to create a monolithic file that includes all of the backed up files. Yet another alternative is for the backup application to store the backed up files in a common directory (i.e., a flat structure) and to create an index (e.g. an XML index) that stores the information on file locations. In these embodiments, when the backed up files are restored the index is used to re-create the directory structure on the data source.

It will be appreciated that according to the method 100, user involvement can be reduced to simply making a physical connection between a data backup system and a data source. While user involvement can thus be minimized, it will be appreciated that options can be provided to the user through a graphical user interface (GUI) provided by the backup application on a display device of the data source. In this way the user, if desired, can customize the backup process by specifying search criteria such as a type of content or a file type to be copied. Additionally, the user can limit the scope of the backup process by drive, directory, folder, file type, file size, or date/time stamp, or the user can deselect a type of content or a specific file, drive, directory, or folder such as a temporary folder or an Internet Explorer directory.

In some embodiments the backup application is configured to automatically direct the data files to a pre-determined address of a networked storage, so that the user does not need to specify the networked storage. One example of a pre-determined address is a Uniform Resource Locator (URL) of a server accessible over the Internet. In such a case backing up the data files includes automatically uploading the data files to the server. A predetermined address can also be used to automatically direct data files to other networked storage such as a network drive, Network Attached Storage (NAS), and so forth.

In some embodiments the backup application allows a user to specify a networked storage destination. In some of these embodiments, the user specifies the backup destination by selecting the networked storage from a drop-down menu or other list. Alternately, the user can enter an address of the networked storage in a text box.

Another example where the backup application can be configured to automatically direct the data files to be backed up to a pre-determined address is within the context of an organization, such as a corporation. For instance, an information technology (IT) department of a corporation can provide a backup device including the backup application to an employee having a computer. The backup application can be configured to selectively back up business-related files such as e-mails and business application data. The data files are then directed to a specific drive on the corporation network that has been dedicated for this purpose. Advantageously, employees working remotely from the office can readily back up files.

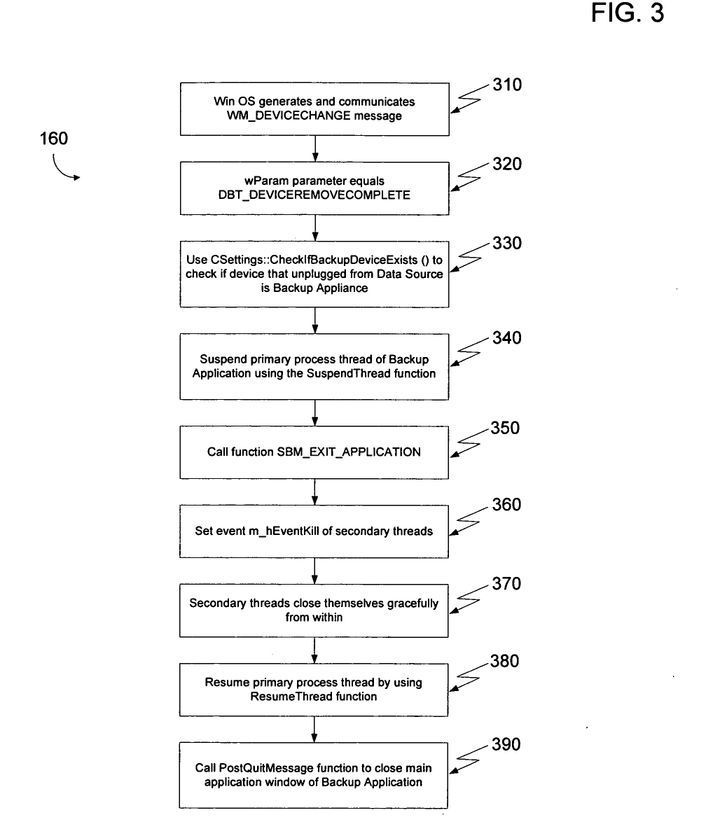

Referring now to FIG. 3, an expanded flowchart representation of step 160 of FIG. 1 for performing a graceful shutdown of the backup application can be seen. Having recognized that the backup device has become unplugged from the data source, Vista generates a WM_DEVICECHANGE message which is communicated to the currently open windows, in step 310. When the backup application running in an open window gets the WM_DEVICECHANGE message, in step 320, it determines if the parameter wParma equals DBT_DEVICEREMOVECOMPLETE which indicates that a removable device has been removed from the data source. A check is then made, in step 330, to determine if the removed device was the backup device using the function CSettings::CheckIfBackupDeviceExiss ( ) whereby if the function returns false this means that the backup device was the removed device. Then, in step 340, the primary process thread of the backup application is suspended by calling the SuspendThread function. Then, in step 350, the function SBM_EXIT_APPLICATION is called and, in step 360, the event m_hEventKill of the secondary threads are set. Using the m_hEventKill function is the preferred method because it forces the secondary threads, in step 370, to close themselves by exiting gracefully from within. Once the secondary threads are closed then the primary thread is resumed, in step 380, using the ResumeThread function. Then, in step 390, the main application window of the backup application is closed using the PostQuitMessage function.

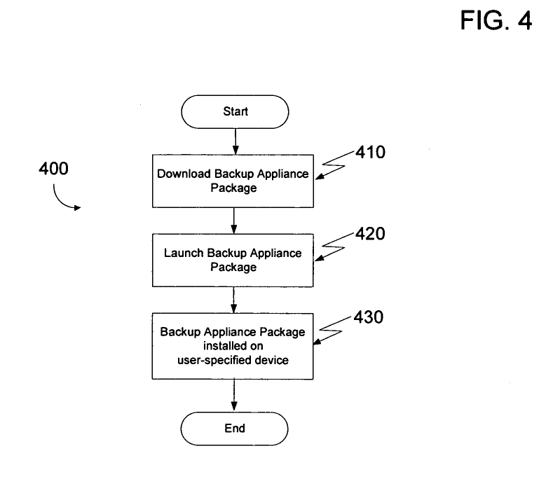

Referring now to FIG. 4, a flowchart representation of an exemplary method 400 for creating a backup device containing the backup application can be seen. The method 400 begins when, in step 410, a backup device package is downloaded from a network location to a data source. The backup device package, which can be in the form of an “.exe” executable file, includes the backup application and the necessary executable software code for an external device to report itself as a removable storage device and an Autorun.inf file configured to direct Vista to the backup application when the AutoRun functionality of Vista is invoked, all as described elsewhere herein. In step 420, the backup device package is launched by, for example, the user of the data source double-clicking the downloaded backup device package. Launching the backup device package causes the backup application, the Autorun.inf file and the removable storage device reporting software components to be copied, in step 430, to a user-specified external device connected to the data source. In this way, a user can turn any external device connected to the data source into a backup device. Such a user-created backup device will then trigger the automatic backup and graceful shutdown operations, as described elsewhere herein, to occur whenever the external device is later plugged into and subsequently removed from a data source running Vista.

In a further embodiment, the computer readable instructions located on the backup device, which instructions include the backup application, can also include an automated installation and launch of software functionality as described in co-pending patent application Ser. No. 12/157,671 hereby incorporated by reference in its entirety. This automated installation and launch of software determines the data source configuration, selects an appropriate version of the backup application accordingly, uninstalls any software already installed on the data source that conflicts with the software to be installed and launched, terminates any process running on the data source that conflicts with the software to be installed and launched, and suppresses displays on the data source while installing and launching the backup application on the data source.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method of backing up data from a data source running a Microsoft Windows Vista operating system, the method comprising:
Vista recognizing that a backup device has been plugged into the data source;
the backup device reporting itself to Vista to be a removable storage device;
Vista locating and launching, in response to the backup device reporting itself to be a removable storage device, a backup application located on the backup device;
the backup application performing a backup operation of the data source;
Vista recognizing that the backup device has become unplugged from the data source; and
the backup application performing a graceful shutdown.

2. The method of claim 1 wherein Vista locating and launching the backup application located on the backup device uses an AutoRun functionality of Vista.

3. The method of claim 1 further comprising the steps of:
downloading a backup device package including the backup application; and
installing the backup device package including the backup application on the backup device.

4. The method of claim 1 wherein the backup application performing a backup operation of the data source comprises saving a file path or directory structure of any data saved from the data source in the backup operation.

5. The method of claim 1 wherein launching the backup application further comprises performing an automated installation and launch of the backup application on the data source.

6. A method of backing up data from a data source running a Microsoft Windows Vista operating system, the method comprising:
plugging the backup device into the data source running Vista;
the backup device reporting itself to Vista as a removable storage device;
launching a backup application located on the backup device using an AutoRun functionality of Vista;
performing a backup operation on the data source using the backup application;
unplugging the backup device from the data source; and
gracefully shutting down the backup application.

7. The method of claim 6 further comprising the steps of:
downloading a backup device package including the backup application; and
installing the backup device package including the backup application on the backup device.

8. The method of claim 7 wherein the backup application performing a backup operation of the data source comprises saving a file path or directory structure of any data saved from the data source in the backup operation.

9. The method of claim 7 wherein launching the backup application further comprises performing an automated installation and launch of the backup application on the data source.

10. A method of backing up data from a data source running a Microsoft Windows Vista operating system, the method comprising:
downloading a backup device package including a backup application, executable code for a backup device to report itself to be a removable storage device and executable code for performing a graceful shutdown of the backup application;
installing the backup device package on the backup device;
plugging the backup device into the data source running Vista;
Vista recognizing that the backup device has been plugged into the data source;
the backup device reporting itself to Vista to be a removable storage device via the executable code for the backup device to report itself as a removable storage device;
Vista locating and launching, in response to the backup device reporting itself to be a removable storage device, the backup application located on the backup device;
the backup application performing a backup operation of the data source;
Vista recognizing that the backup device has become unplugged from the data source; and
performing a graceful shutdown of the backup application using the executable code for performing the graceful shutdown of the backup application.

11. The method of claim 10 wherein Vista locating and launching the backup application located on the backup device uses an AutoRun functionality of Vista.

12. The method of claim 10 wherein the backup application performing a backup operation of the data source comprises saving a file path or directory structure of any data saved from the data source in the backup operation.

13. The method of claim 10 wherein launching the backup application further comprises performing an automated installation and launch of the backup application on the data source.
